(19) United States
(12) Patent Application Publication
(10) Pub. No.: US 2025/0178078 A1
(43) Pub. Date: Jun. 5, 2025

(54) TEMPERATURE CONTROL APPARATUS AND PROCESS FOR HIGH-FLUX CONTINUOUS CASTING AND ROLLING OF ALUMINUM ALLOY PLATE

(71) Applicants: ZHENGZHOU UNIVERSITY, Zhengzhou, Henan (CN); LUOYANG LONGDING ALUMINUM CO., LTD., Luoyang, Henan (CN)

(72) Inventors: Shaokang GUAN, Zhengzhou (CN); Guangxi LU, Zhengzhou (CN); Cong XU, Zhengzhou (CN); Jiahui LIU, Zhengzhou (CN); Anle ZHANG, Zhengzhou (CN); Bingxu JI, Zhengzhou (CN)

(73) Assignees: ZHENGZHOU UNIVERSITY, Zhengzhou, Henan (CN); LUOYANG LONGDING ALUMINUM CO., LTD., Luoyang, Henan (CN)

(21) Appl. No.: 18/839,429

(22) PCT Filed: Oct. 30, 2023
(86) PCT No.: PCT/CN2023/127792

§ 371 Date: Aug. 18, 2024

(30) Foreign Application Priority Data
Nov. 15, 2022 (CN) 202211427300.9

(51) Int. Cl. B22D 11/22; B22D 11/06; B22D 11/124; B22D 11/128

(52) U.S. Cl. CPC B22D 11/22; B22D 11/0605; B22D 11/1246; B22D 11/1284

(57) ABSTRACT

The present invention provides a continuous rolling temperature control process for high-flux continuous casting and direct rolling of a continuous aluminum alloy cast slab, comprising a continuous casting machine, a through-beam laser transmitter K, a controller, a spraying head, and a spraying system. A liquid-state aluminum alloy metal melt passes through the continuous casting machine and then is cooled and solidified to form a continuous cast slab; the movement direction of the continuous cast slab is controlled by a lifting table so that the continuous cast slab passes through an interior of a traction machine and extends into a continuous rolling machine; and the through-beam laser transmitter K is arranged between the continuous casting machine and the traction machine. According to the present invention, comprehensive performance indicators required by different series of aluminum alloys under high-flux continuous casting and direct rolling conditions are distinguished, and the continuous rolling temperatures of continuous cast slabs of different series of high-flux continuous cast and rolled aluminum alloy sheets are correspondingly designed and controlled. A preset continuous rolling temperature enables the comprehensive performance of different series of aluminum alloys to reach a product quality standard, reduces interior defects and alleviates the problems of segregation and the like. The flow velocity (or flow rate) of the spraying system can be controlled to reduce the loss of a cooling liquid (an emulsion), thereby reducing the cost, and achieving the purpose of energy conservation and emission reduction.

### TECHNICAL FIELD

The present application belongs to the field of aluminum alloy sheet processing, in particular relates to a continuous rolling temperature control process for high-flux continuous casting and direct rolling of a continuous aluminum alloy cast slab.

### BACKGROUND

Pure aluminum is rarely used in practice. In actual production, aluminum alloys with excellent performance are prepared by adding various alloy elements with different contents (such as Mn, Mg, Cu and Ti, etc.) to pure aluminum. Because of its high specific strength, good plasticity, excellent conductivity, low cost, easy recycling and reuse, aluminum alloy conforms to the concepts of green environmental protection, energy conservation and emission reduction, and ecological environment protection advocated by China's current scientific and technological development, so it is widely used in rail transportation, aerospace flight, electronic equipment, food, medical and other fields. However, the uses of different series of aluminum alloys vary greatly. 5052-aluminum sheets are often used as various automotive parts, sheet metal parts, and other mechanical parts of automobiles and aircrafts. (3003+Zn)-aluminum sheets are often used as core materials for automobile radiator fins. 8011-aluminum sheets are commonly used as aluminum foil due to its significantly higher performance than pure aluminum foil, and are widely used in aluminum foil application scenarios. 1080-aluminum sheets can ensure good formability and are widely used in conductive materials, chemical industry containers and reflective sheets, etc.

The hot-rolling and cold-rolling process technology and equipment on DC (direct-chill) casting slabs used in traditional aluminum alloy sheet rolling require large investments, with a long return-on-investment time, and have complicated production procedures. At present, the production process of high-flux continuous casting and direct rolling technology is short, fast, and has relatively few procedures, but the hot continuous rolling temperature in this process has a critical influence on the mechanical properties of aluminum alloys. If the temperature is too high, although the alloy is easy to roll, it is difficult for the final performance to meet the factory standards; if the temperature is too low, rolling is likely to cause problems such as cracking of the rolled sheet. At the same time, due to the different composition, microstructure, and factory performance indicators of different types of sheet products, different types of sheets have different requirements for hot continuous rolling temperature. Therefore, it is urgent to develop a temperature control apparatus and process for high-flux continuous casting and direct rolling of aluminum alloy sheet to meet the comprehensive performance requirements of different series of aluminum sheet products.

### SUMMARY OF THE INVENTION

In order to solve the above technical problems, the present invention provides a continuous rolling temperature control process for high-flux continuous casting and direct rolling of a continuous aluminum alloy cast slab, so as to realize the normal production and processing of high-flux continuous casting and direct rolling of aluminum alloy sheet while meeting the comprehensive performance requirements of different series of aluminum sheet products.

A continuous rolling temperature control process for high-flux continuous casting and direct rolling of a continuous aluminum alloy cast slab, comprising a continuous casting machine, a through-beam laser transmitter K, a through-beam laser receiver G, a controller, a spraying head, a spraying system, a first infrared temperature measuring system and a second infrared temperature measuring system, the continuous casting machine comprises two “HC3, HC4” type steel belts, and a continuous cast slab is formed on the continuous casting machine, a movement direction of the continuous cast slab is controlled by a lifting table so that the continuous cast slab passes through an interior of a traction machine and extends into a triple continuous rolling machine; and the through-beam laser transmitter K and the through-beam laser receiver G are arranged between the continuous casting machine and the traction machine; the through-beam laser transmitter K and the through-beam laser receiver G are connected to the controller through wires; the spraying system comprises a manual valve DO, a first electromagnetic valve D1, a second electromagnetic valve D2 and a spraying head; the spraying system is arranged between the continuous casting machine and the continuous rolling machine, close to the continuous casting machine, the manual valve DO, the first electromagnetic valve D1 and the second electromagnetic valve D2 are all electrically connected to the controller; the outlet ends of the manual valve DO, the first electromagnetic valve D1 and the second electromagnetic valve D2 are all connected to the same spraying head through a pipeline, and the spraying head is provided in multiple groups.

In the continuous rolling temperature control process for high-flux continuous casting and direct rolling of a continuous aluminum alloy cast slab, the temperature control apparatus comprises a spraying system, the spraying system is arranged between the continuous casting machine and the continuous rolling machine, close to the continuous casting machine, the spraying system is provided with a plurality of spraying heads distributed in the longitudinal direction of the continuous cast slab and the rolled piece. The sheet temperature control apparatus comprises a sheet traction machine, the continuous cast slab and the rolled piece are moved on the traction roller when passing through the sheet traction machine, a cooling liquid used in the spraying system is a lubricating metal-cooling liquid; and the emulsion flow rate depends on the spraying speed that has been set.

In the continuous rolling temperature control process for high-flux continuous casting and direct rolling of a continuous aluminum alloy cast slab, the temperature control apparatus is used in a production process of high-flux continuous casting and direct rolling of an aluminum alloy. The specific production apparatus comprises a continuous casting machine, a triple continuous rolling machine, a sheet traction machine, a traction roller, and an aluminum alloy cast slab and the like. In the temperature control apparatus, the continuous cast slab and the rolled piece are moved on the traction rollers when passing through the sheet traction machine. The temperature control apparatus comprises a through-beam laser transmitter K, a through-beam laser receiver G, a controller, a spraying head, a spraying pipeline, an infrared temperature measuring apparatus, and the like. The through-beam laser transmitter K and the through-beam laser receiver G are respectively arranged in front of the triple continuous rolling machine and are both connected to the controller.

In the above-mentioned continuous rolling temperature control process for high-flux continuous casting and direct rolling of a continuous aluminum alloy cast slab, the spraying supply pipeline is provided with a corresponding manual valve and corresponding electromagnetic valves, and the electromagnetic valves controlled by the controller will open automatically after receiving a signal. The cooling liquid used in the spraying system is a lubricating metal-cooling liquid.

In the above-mentioned continuous rolling temperature control process for high-flux continuous casting and direct rolling of a continuous aluminum alloy cast slab, the aluminum alloy sheet produced by the continuous casting and direct rolling comprises, but not limited to, 5052-aluminum alloy, (3003+Zn)-aluminum alloy, 1080-aluminum alloy and 8011-aluminum alloy. The aluminum alloy sheet produced by the continuous casting and direct rolling has a thickness of 19 mm to 3.8 mm.

Furthermore, the parameters of the spraying system can be set freely, and the spraying supply pipeline is provided with a corresponding manual valve and corresponding electromagnetic valves. The electromagnetic valves controlled by the controller will open automatically after receiving a signal. The spraying speed is synergistically controlled by the first electromagnetic valve and the second electromagnetic valve, and the manual valve can be controlled manually.

Furthermore, the cooling liquid used in the spraying system is JR3A metal-specific lubricating emulsion cooling liquid.

Furthermore, the aluminum alloy sheet produced by the continuous casting and direct rolling comprises, but not limited to, 5052-aluminum alloy, (3003+Zn)-aluminum alloy, 1080-aluminum alloy and 8011-aluminum alloy. The aluminum alloy slab and sheet produced by the continuous casting and direct rolling has a thickness of 19 mm to 3.8 mm.

Further, the following steps are included:
S1. aluminum liquid obtained after alloying, degassing and slagging-off flows into a space between the two “HC3, HC4” type steel belts that perform wide-width circular rotation and correspond to each other for casting in the continuous casting machine through a casting nozzle, a continuous casting speed is 110 m/min, a width of the continuous cast slab is 1980 mm, a thickness of the cast slab is 19 mm, and an error range is +1 mm, a temperature of the continuous cast slab is initially measured at the spraying system by the corresponding infrared temperature measuring device to obtain an initial rolling temperature T₁;
S2. after the initial temperature measurement, the continuous cast slab bends downward due to gravity, and then bends upward after being adjusted by the lifting device, resulting in a primary bending, and as the continuous cast slab moves forward, the continuous cast slab bends downward again due to gravity, so as to gradually form a secondary bending, and subsequently, the continuous cast slab is adjusted by traction rollers and delivered into the triple rolling machine, the cast slab is rolled three times with a reduction rate of more than 30% each time to obtain a finished product;
S3. when a height of the secondary bending of the continuous cast slab exceeds a height H₂ of the through-beam laser transmitter K (2) and the through-beam laser receiver G (3), the spraying system starts to spray emulsion at a certain spraying speed, the spraying speed is synergistically controlled by the first electromagnetic valve (6) and the second electromagnetic valve (7), and as the spraying process proceeds, the height of the secondary bending of the continuous cast slab gradually decreases, and when the height of the secondary bending of the continuous cast slab becomes lower than another height H₁ of the through-beam laser transmitter K (2) and the through-beam laser receiver G (3), the spraying system stops spraying;
S4, obtaining initial rolling temperatures and emulsion spraying speeds corresponding to different sheet types according to temperatures initial measured when the height of the secondary bending of the continuous cast slab is respectively higher than H₂ and lower than H₁;
S5. measuring a temperature of the continuous cast slab in front of the third rolling unit by the corresponding infrared temperature measuring device to obtain a final rolling temperature T₂, and controlling the final rolling temperature for a rolled piece by the spraying system, so as to finally obtain a 3.8 mm sheet, and then carrying out a heat treatment on the sheet to obtain a finished product on which comprehensive performance testing is performed; and
S6. handling of abnormal situations: 1) if the height of the secondary bending of the continuous cast slab is higher than H₂, even if the initial rolling temperature T₁ or the final rolling temperature T₂ is within an empirical optimal value range, continue spraying until the height of the secondary bending of the continuous cast slab becomes lower than H₁; 2) if the spraying speed of the spraying device is abnormal, using the manual valve to manually adjust the spraying speed.

The continuous rolling temperature control process for high-flux continuous casting and direct rolling of a continuous aluminum alloy cast slab is implemented in the above-mentioned continuous rolling temperature control apparatus for high-flux continuous casting and direct rolling of a continuous aluminum alloy cast slab:

(1) The cast slab produced by the casting machine has a certain residual temperature when it is transported to the triple continuous rolling machine by the conveyor belt.

(2) The rolling temperature has a certain degree of influence on the segregation and comprehensive performance of aluminum alloy sheets. The rolling temperatures required for different alloys are generally different, and the influence of hot rolling temperature on the performance has a large fluctuation range.

(3) Different continuous rolling temperature requirements can be achieved by means of spraying for different grades of 5052-aluminum alloy, (3003+Zn)-aluminum alloy, 1080-aluminum alloy, and 8011-aluminum alloy in actual production.

Furthermore, for 5052-aluminum alloy, the initial rolling temperature T₁ is generally 460° C. to 480° C., the final rolling temperature T₂ is generally 400° C. to 420° C., the conveyor belt transmission speed is configured at 10 m/min, and the emulsion spraying speed is configured at 2 m/s. After the final rolling temperature treatment in this process, the 5052-aluminum alloy undergoes recrystallization, the alloy microstructure is approximately equiaxed crystals and the grain size is uniform, and the defects such as orange peel and pitting on the surface of the sheet are alleviated macroscopically. The tensile strength and yield strength of the finished sheet are simultaneously reduced, while the elongation rate is increased, and the sheet crimp ratio reaches 100%, the forming performance (cupping and bending) reaches the factory standard, and warping completely disappears.

The continuous rolling temperature control process for high-flux continuous casting and direct rolling of a continuous aluminum alloy cast slab, wherein, for ((3003+Zn)-aluminum alloy, the initial rolling temperature T₁ is generally 500° C. to 520° C., the final rolling temperature T₂ is generally 350° C. to 400° C., the conveyor belt transmission speed is configured at 10 m/min, and the emulsion spraying speed is configured at 1 m/s. After the final rolling temperature treatment in this process, the recrystallization time of the (3003+Zn)-aluminum alloy is shortened, the grain growth rate is low, and the mechanical properties close to those of the O-state material are obtained, and the sheet crimp ratio reaches 100%, the forming performance (cupping and bending) reaches the factory standard, and warping completely disappears.

Furthermore, for 1080-aluminum alloy, the initial rolling temperature T₁ is generally 420° C. to 480° C., the final rolling temperature T₂ is generally 350° C. to 380° C., the conveyor belt transmission speed is configured at 10 m/min, and the emulsion spraying speed is configured at 1.5 m/s. After the final rolling temperature treatment in this process, the elongation rate of 1080-aluminum alloy is greatly increased, and its comprehensive performance is improved in the application scenario of air conditioning foil.

Furthermore, for 8011-aluminum alloy, the initial rolling temperature T₁ is generally 360° C. to 400° C., the final rolling temperature T₂ is generally 300° C. to 340° C., the conveyor belt transmission speed is configured at 10 m/min, and the emulsion spraying speed is configured at 3 m/s. After the final rolling temperature treatment in this process, the tensile strength reaches 140 MPa, the elongation rate reaches 8%, the sheet crimp ratio performance reaches 100%, and warping completely disappears, which is significantly better than pure aluminum and is widely used in building materials.

Compared with the prior art, the present invention has the following beneficial effects:

1. According to the present invention, comprehensive performance indicators required by different series of aluminum alloys are distinguished, and the continuous rolling temperatures for different series of aluminum alloys are correspondingly designed and controlled. A preset hot rolling temperature enables the comprehensive performance of different series of aluminum alloys to reach a factory standard, reduces internal inclusions in the metal, reduces interior defects and alleviates the problems of segregation and the like. The flow velocity of the spraying system can be controlled to reduce the loss of a cooling liquid (an emulsion), thereby reducing the cost, and achieving the environment-protection purpose of energy conservation and emission reduction.

2. This apparatus solves the problems of poor sheet surface quality, severe segregation, and mechanical properties not meeting factory requirements caused by the inability to accurately control the hot rolling temperature in the prior art process of high-flux continuous casting and direct rolling. The flow rate control by means of the spraying system can reduce the loss of a cooling liquid (an emulsion), thereby reducing the cost, and achieving the environment-protection purpose of energy conservation and emission reduction.

### BRIEF DESCRIPTION OF THE DRAWINGS

FIG. 1 is a schematic diagram of the main structure of the present invention;

FIG. 2 is a schematic diagram of the structure of the spraying head of the present invention.

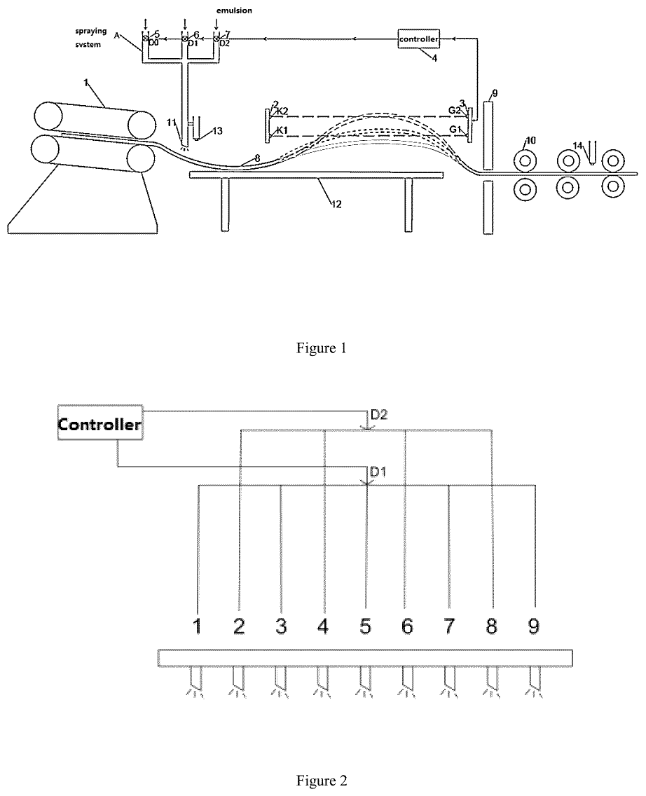

In the figures: 1. continuous casting machine; 2. through-beam laser transmitter K; 3. through-beam laser receiver G; 4. controller; 5. manual valve D0; 6. first electromagnetic valve D1; 7. second electromagnetic valve D2; 8. slab; 9. traction machine; 10. continuous rolling machine; 11. spraying head; 12. lifting table; 13. first infrared temperature measuring device; 14. second infrared temperature measuring device.

### DETAILED DESCRIPTION OF SPECIFIC EMBODIMENTS

The embodiments of the present invention are described hereinafter in further detail in conjunction with the drawings and examples. The following examples are used to illustrate the present invention, but are not intended to limit the scope of the present invention.

### Example 1

In this example, the chemical composition of 5052-aluminum alloy is as follows: 2.50% of Mg, 0.25% of Si, 0.40% of Fe, 0.20% of Cr, and balance of Al, in percentage by mass.

The present invention provides a continuous rolling temperature control process for high-flux continuous casting and direct rolling of a continuous aluminum alloy cast slab, comprising the following steps:

(1) The type of aluminum alloy at the spraying system was set to Al5052, the emulsion starts to circulate automatically, the conveyor belt transmission power was 10 m/min, and the spraying system device operated at full load.

(2) emulsion was delivered by 9 spraying heads at a spraying speed of 2 m/s.

(3) after passing through the spraying system, the cast slab with a suitable temperature was delivered to the initial rolling machine via a conveyor belt for initial rolling.

### Example 2

In this example, the chemical composition of (3003+Zn)-aluminum alloy is as follows: 1.50% of Zn, 0.70% of Si, 0.50% of Fe, 1.30% of Mn, 0.15% of Cu, and balance of Al, in percentage by mass.

The present invention provides a temperature control process for high-flux continuous casting and direct rolling of a continuous aluminum alloy cast slab, comprising the following steps:

(1) The type of aluminum alloy at the spraying system was set to (3003+Zn)-aluminum, the emulsion starts to circulate automatically, the conveyor belt transmission power was 10 m/min, and the spraying system device operated at full load.

(2) emulsion was delivered by 9 spraying heads at a spraying speed of 1 m/s.

(3) after passing through the spraying system, the cast slab with a suitable temperature was delivered to the initial rolling machine via a conveyor belt for initial rolling.

### Example 3

In this example, the chemical composition of 1080-aluminum alloy is as follows: 0.03% of Zn, 0.15% of Si, 0.15% of Fe, 0.03% of Cu, and balance of Al, in percentage by mass.

The present invention provides a temperature control process for high-flux continuous casting and direct rolling of a continuous aluminum alloy cast slab, comprising the following steps:

(1) The type of aluminum alloy at the spraying system was set to 1080-aluminum, the emulsion starts to circulate automatically, the conveyor belt transmission power was 10 m/min, and the spraying system device operated at half load.

(2) emulsion was delivered by 4 spraying heads at a spraying speed of 1.5 m/s.

(3) after passing through the spraying system, the cast slab with a suitable temperature was delivered to the initial rolling machine via a conveyor belt for initial rolling.

### Example 4

In this example, the chemical composition of 8011-aluminum alloy is as follows: 0.90% of Si, 1.00% of Fe, 0.20% of Mn, 0.10% of Cu, and balance of Al, in percentage by mass.

The present invention provides a temperature control process for high-flux continuous casting and direct rolling of a continuous aluminum alloy cast slab, comprising the following steps:

(1) The type of aluminum alloy at the spraying system was set to 8011-aluminum alloy, the emulsion starts to circulate automatically, the conveyor belt transmission power was 10 m/min, and the spraying system device operated at half load.

(2) emulsion was delivered by 4 spraying heads at a spraying speed of 3 m/s.

(3) after passing through the spraying system, the cast slab with a suitable temperature was delivered to the initial rolling machine via a conveyor belt for initial rolling.

The embodiments of the present invention are provided for the purpose of illustration and description. Although the examples of the present invention have been shown and described above, it can be understood that the above examples are exemplary and cannot be understood as limitations of the present invention. For those of ordinary skill in the art, other different forms of changes, modifications, substitutions or variations can also be made within the scope of the present invention.

1. A continuous rolling temperature control apparatus for high-flux continuous casting and direct rolling of a continuous aluminum alloy cast slab, comprising a continuous casting machine (1), a through-beam laser transmitter K (2), a through-beam laser receiver G (3), a controller (4), a spraying head (11), a spraying system, a first infrared temperature measuring system (13) and a second infrared temperature measuring system (14), wherein the continuous casting machine (1) comprises two “HC3, HC4” type steel belts, a liquid-state aluminum alloy metal melt is cooled and solidified after going through the continuous casting machine (1) to form a continuous cast slab (8), a movement direction of the continuous cast slab (8) is controlled by a lifting table so that the continuous cast slab (8) passes through an interior of a traction machine (9) and extends into a triple continuous rolling machine (10); and the through-beam laser transmitter K (2) and the through-beam laser receiver G (3) are arranged between the continuous casting machine (1) and the traction machine (9); the through-beam laser transmitter K (2) and the through-beam laser receiver G (3) are connected to the controller (4) through wires; the spraying system comprises a manual valve (5), a first electromagnetic valve (6), a second electromagnetic valve (7) and a spraying head (11); the manual valve (5), the first electromagnetic valve (6) and the second electromagnetic valve (7) are all electrically connected to the controller (4); the outlet ends of the manual valve (5), the first electromagnetic valve (6) and the second electromagnetic valve (7) are all connected to the same spraying head (11) through a pipeline, and the spraying head (11) is provided in multiple groups; infrared temperature measuring systems include an infrared temperature measuring device (13) arranged at the spraying system and an infrared temperature measuring device (14) arranged in front of a third rolling unit of the triple continuous rolling machine;
a cooling liquid used in the spraying system is a lubricating metal-cooling liquid;
the aluminum alloy continuous cast slab produced by the continuous casting and direct rolling comprises, but not limited to, 5052-aluminum alloy, (3003+Zn)-aluminum alloy, 1080-aluminum alloy and 8011-aluminum alloy;
a control process of the apparatus comprises the following steps:
S1. aluminum liquid obtained after alloying, degassing and slagging-off flows into a space between the two “HC3, HC4” type steel belts that perform wide-width circular rotation and correspond to each other for casting in the continuous casting machine through a casting nozzle, a continuous casting speed is 110 m/min, a width of the continuous cast slab is 1980 mm, a thickness of the cast slab is 19 mm, and an error range is ±1 mm, a temperature of the continuous cast slab is initially measured at the spraying system by the corresponding infrared temperature measuring device to obtain an initial rolling temperature T₁;
S2. after the initial temperature measurement, the continuous cast slab bends downward due to gravity, and then bends upward after being adjusted by the lifting device, resulting in a primary bending, and as the continuous cast slab moves forward, the continuous cast slab bends downward again due to gravity, so as to gradually form a secondary bending, and subsequently, the continuous cast slab is adjusted by traction rollers and delivered into the triple rolling machine, the cast slab is rolled three times with a reduction rate of more than 30% each time to obtain a finished product;
S3. when a height of the secondary bending of the continuous cast slab exceeds a height H₂ of the through-beam laser transmitter K (2) and the through-beam laser receiver G (3), the spraying system starts to spray emulsion at a certain spraying speed, the spraying speed is synergistically controlled by the first electromagnetic valve (6) and the second electromagnetic valve (7), and as the spraying process proceeds, the height of the secondary bending of the continuous cast slab gradually decreases, and when the height of the secondary bending of the continuous cast slab becomes lower than another height H₁ of the through-beam laser transmitter K (2) and the through-beam laser receiver G (3), the spraying system stops spraying;
S4, obtaining initial rolling temperatures and emulsion spraying speeds corresponding to different sheet types according to temperatures initial measured when the height of the secondary bending of the continuous cast slab is respectively higher than H₂ and lower than H₁;
S5. measuring a temperature of the continuous cast slab in front of the third rolling unit by the corresponding infrared temperature measuring device to obtain a final rolling temperature T₂, and controlling the final rolling temperature for a rolled piece by the spraying system, so as to finally obtain a 3.8 mm sheet, and then carrying out a heat treatment on the sheet to obtain a finished product on which comprehensive performance testing is performed; and
S6. handling of abnormal situations: 1) if the height of the secondary bending of the continuous cast slab is higher than H₂, even if the initial rolling temperature T₁ or the final rolling temperature T₂ is within an empirical optimal value range, continue spraying until the height of the secondary bending of the continuous cast slab becomes lower than H₁; 2) if the spraying speed of the spraying device is abnormal, using the manual valve to manually adjust the spraying speed.

2. The continuous rolling temperature control apparatus for high-flux continuous casting and direct rolling of a continuous aluminum alloy cast slab according to claim 1, wherein: the 5052-aluminum alloy has an initial rolling temperature T₁ ranging from 460° C. to 480° C., and a final rolling temperature T₂ ranging from 400° C. to 420° C., with a conveyor belt transmission speed configured at 10 m/min, and an emulsion spraying speed configured at 2 m/s.

3. The continuous rolling temperature control apparatus for high-flux continuous casting and direct rolling of a continuous aluminum alloy cast slab according to claim 1, wherein: the (3003+Zn)-aluminum alloy has an initial rolling temperature T₁ ranging from 500° C. to 520° C., and a final rolling temperature T₂ ranging from 350° C. to 400° C., with a conveyor belt transmission speed configured at 10 m/min, and an emulsion spraying speed configured at 1 m/s.

4. The continuous rolling temperature control apparatus for high-flux continuous casting and direct rolling of a continuous aluminum alloy cast slab according to claim 1, wherein: the 1080-aluminum alloy has an initial rolling temperature T₁ ranging from 420° C. to 480° C., and a final rolling temperature T₂ ranging from 350° C. to 380° C., with a conveyor belt transmission speed configured at 10 m/min, and an emulsion spraying speed configured at 1.5 m/s.

5. The continuous rolling temperature control apparatus for high-flux continuous casting and direct rolling of a continuous aluminum alloy cast slab according to claim 1, wherein: the 8011-aluminum alloy has an initial rolling temperature T₁ ranging from 360° C. to 400° C., and a final rolling temperature T₂ ranging from 300° C. to 340° C., with a conveyor belt transmission speed configured at 10 m/min, and an emulsion spraying speed configured at 3 m/s.
